(19) United States
(12) Patent Application Publication
(10) Pub. No.: US 2024/0242285 A1
(43) Pub. Date: Jul. 18, 2024

(54) SYSTEM AND METHOD FOR INVESTMENT CACHE CONTRIBUTION

(71) Applicant: Truist Bank, Charlotte, NC (US)

(72) Inventors: Melissa Danielle Mack, Atlanta, GA (US); Kathryn Leigh Borneman, Suwanee, GA (US); Jose I. Zambrano, Charlotte, NC (US); Ronald Lee Ratcliffe, JR., Garner, NC (US); Ryan William Kinsella, Charlotte, NC (US)

(73) Assignee: Truist Bank, Charlotte, NC (US)

(21) Appl. No.: 18/156,234

(22) Filed: Jan. 18, 2023

(51) Int. Cl. G06Q 40/06; G06Q 40/10

(52) U.S. Cl. CPC G06Q 40/06; G06Q 40/10

(57) ABSTRACT

A system and method for investment cache management comprising a computing system including at least one processor and at least one memory, wherein the computing system executes computer-readable instructions for interaction with at least one user device having a graphical user interface, and a network connection operatively connecting the at least one user device to the computing system, wherein, upon execution of the computer-readable instructions, the at least one processor performs steps comprising: receiving, via the graphical user interface, user data; determining at least one time period for contributing resources to a cache based upon the user data; displaying the at least one time period for contributing resources to the cache on the graphical user interface; and receiving, via the graphical user interface, a user selection of a desired time period for contributing resources to the cache.

### FIELD

This present disclosure is related generally to the field of investment caches, and more particularly embodiments of the present disclosure relate to a system and method for investment cache contribution.

### BACKGROUND

More than 70 million U.S. residents will reach retirement age within the next two decades. Driven primarily by a wave of aging “Baby Boomers”, this massive demographic shift will profoundly impact American society. Traditionally, Social Security, employer-provided benefits and personal savings have constituted the “three-legged stool” of retirement security. As the long-run actuarial deficits of the Social Security program continued to worsen in 2012, the Trustees of the Social Security and Medicare trust funds warned that lawmakers should be aware that it will become increasingly difficult to avoid adverse effects on current beneficiaries, those close to retirement and low-income beneficiaries in all age cohorts if legislative changes are delayed much longer. With uncertainty about future funding, many observers expect a reduction in the portion of future retirement income that will be provided through Social Security benefits. As such, there had been a rapid shift from saving through employer-managed Defined Benefit (DB) pensions to Individual Retirement Accounts (IRAs).

The IRAs make it easier for individuals to start saving for retirement with the hope that many continue to save, thereby improving the retirement readiness of the overall population. In order for a 25 year old individual to achieve a secure retirement at age 67, without taking excessive investment risk, their total savings rate should be at least 15% of their earnings each year. The total savings rate required by older individuals depends on how much they have saved in previous years and whether they have earned a positive return or incurred losses on the investment of retirement resources.

One of the greatest challenges faced by individuals is trying to keep track of contributions and contribution limits for IRAs. A number of organizations also offer online services to help individuals contribute to their IRAs for a current year. One drawback of the current state of the art is that simply allowing IRA contributions for the current year does not permit individuals to take full advantage of the rules of the Internal Revenue Service and maximize their retirement contributions and savings.

Accordingly, it would be desirable to provide a system and method for investment cache contribution which applies and optimizes rules to maximize retirement savings.

### SUMMARY

In concordance and agreement with the presently described subject matter, a system and method for investment cache contribution which applies and optimizes rules to maximize retirement savings, have surprisingly been discovered.

In an embodiment, a system for contributing to a cache, comprises: a computing system including at least one processor and at least one memory, wherein the computing system executes computer-readable instructions for interaction with at least one user device having a graphical user interface; and a network connection operatively connecting the at least one user device to the computing system; wherein, upon execution of the computer-readable instructions, the at least one processor performs steps comprising: receiving, via the graphical user interface, user data; determining at least one time period for contributing resources to a cache based upon the user data; displaying the at least one time period for contributing resources to the cache on the graphical user interface; and receiving, via the graphical user interface, a user selection of a desired time period for contributing resources to the cache.

In some embodiments, the system further comprises determining at least one predetermined contribution limit for the cache based upon the user data.

In some embodiments, the at least one predetermined contribution limit includes at least one of a standard contribution limit and a catch-up contribution limit.

In some embodiments, the cache is an individual retirement account.

In some embodiments, the system further comprises displaying on the graphical user interface at least one frequency for contributing resources to the cache; and receiving, via the graphical user interface, a user selection of a desired frequency for contributing resources to the cache.

In some embodiments, the at least one time period for contributing to the cache is at least one of a current tax year and a previous tax year.

In some embodiments, the at least one time period for contributing to the cache is a current tax year when a time deadline has passed.

In some embodiments, the time deadline is a due date for filing Federal income tax returns for a previous tax year.

In some embodiments, the system further comprises providing at least one input field on the graphical user interface associated with a desired amount of resources to be contributed to the cache; and receiving, via the graphical user interface, the desired amount of resources to be contributed to the cache.

In some embodiments, the system further comprises transmitting a communication to the at least one user device when the desired amount of resources to be contributed to the cache exceeds at least one predetermined contribution limit based upon the user data.

In another embodiment, a method for contributing resources to a cache, comprises the steps of: providing a computing system including at least one processor and at least one memory, wherein the computing system executes computer-readable instructions for interaction with at least one user device having a graphical user interface, and a network connection operatively connecting the at least one user device to the computing system; receiving, via the graphical user interface, user data; determining at least one time period for contributing resources to a cache based upon the user data; displaying the at least one time period for contributing resources to the cache on the graphical user interface; and receiving, via the graphical user interface, a user selection of a desired time period for contributing resources to the cache.

In some embodiments, the method further comprises determining at least one predetermined contribution limit for the cache based upon the user data.

In some embodiments, the at least one predetermined contribution limit includes at least one of a standard contribution limit and a catch-up contribution limit.

In some embodiments, the cache is an individual retirement account.

In some embodiments, the method further comprises displaying on the graphical user interface at least one frequency for contributing resources to the cache; and receiving, via the graphical user interface, a user selection of a desired frequency for contributing resources to the cache.

In some embodiments, the at least one time period for contributing to the cache is at least one of a current tax year and a previous tax year.

In some embodiments, the at least one time period for contributing to the cache is a current tax year when a time deadline has passed.

In some embodiments, the method further comprises providing at least one input field on the graphical user interface associated with a desired amount of resources to be contributed to the cache; and receiving, via the graphical user interface, the desired amount of resources to be contributed to the cache.

In some embodiments, the method further comprises transmitting a communication to the at least one user device when the desired amount of resources to be contributed to the cache exceeds at least one predetermined contribution limit based upon the user data.

In yet another embodiment, a computer-implemented method for contributing resources to a cache using a graphical user interface, the method comprises: receiving, via the graphical user interface, user data; determining, by a processor, at least one time period for contributing resources to a cache based upon the user data; displaying the at least one time period for contributing resources to the cache on the graphical user interface; and receiving, via the graphical user interface, a user selection of a desired time period for contributing resources to the cache.

The features, functions, and advantages that have been discussed may be achieved independently in various embodiments of the present disclosure or may be combined in yet other embodiments, further details of which can be seen with reference to the following description and drawings.

### BRIEF DESCRIPTION OF THE DRAWINGS

The drawings described herein are for illustrative purposes only of selected embodiments and not all possible implementations, and are not intended to limit the scope of the present disclosure. Having thus described embodiments of the present disclosure in general terms, reference will now be made to the accompanying drawings, wherein:

FIG. 1 is a schematic diagram illustrating an enterprise system and environment thereof for implementing an investment cache management application, in accordance with an embodiment of the present disclosure; and

FIG. 2 is a flow diagram illustrating an exemplary method for contributing resources to an investment cache via a graphical user interface of a user device provided by an investment cache management application.

### DETAILED DESCRIPTION

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the present disclosure and enable one of ordinary skill in the art to make, use, and practice the present disclosure.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present disclosure described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the present disclosure.

While certain exemplary embodiments have been described and shown in the accompanying drawings, it is to be understood that such embodiments are merely illustrative of, and not restrictive on, the broad present disclosure, and that this present disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the present disclosure. Therefore, it is to be understood that, within the scope of the included claims, the present disclosure may be practiced other than as specifically described herein.

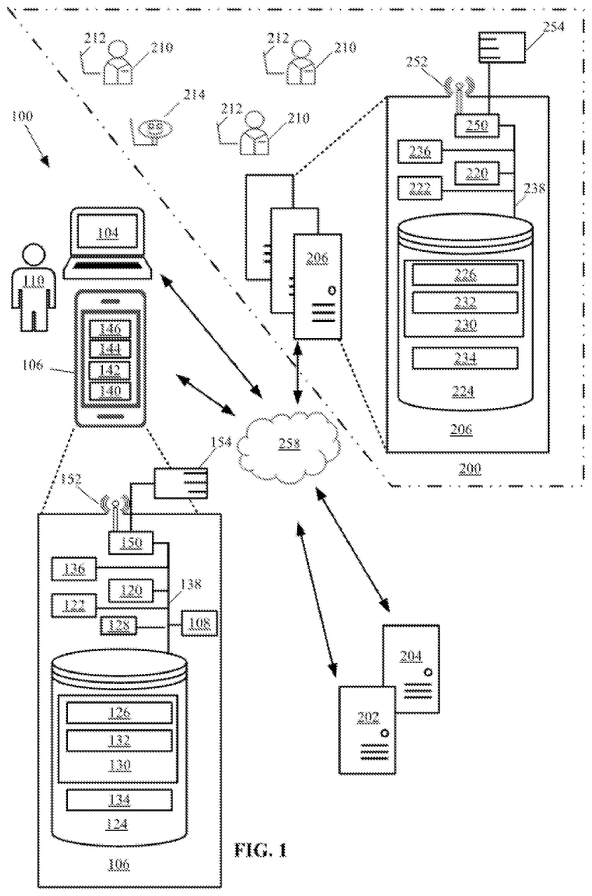

FIG. 1 illustrates a system 100 and environment thereof, according to at least one embodiment, by which a user 110 benefits through use of services and products of an enterprise system 200. The environment may include, for example, a distributed cloud computing environment (private cloud, public cloud, community cloud, and/or hybrid cloud), an on-premise environment, fog computing environment, and/or an edge computing environment. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including an area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a global positioning system device (GPS) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes. In yet another example, the external systems 202 and 204 represent third party systems such as the Internal Revenue Service system and/or another third party vendor configured to interact with the enterprise system 200 to provide individual contribution limits based upon user profile information.

In certain embodiments, one or more of the systems such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computing system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

As discussed hereinabove, one of the programs 230 of the enterprise system 200 may be the application 232. In certain embodiments, the application 232 may be an investment cache management application. The application 232 may be used by an enterprise to provide the users 110 with increased transparency, control, and insights into use and optimization of their investment caches (e.g., individual retirement accounts). The application 232 may be accessed using an online login into the enterprise system 200 via the user device, referring to either or both of the computing device 104 and the mobile device 106. The application 232 may be configured to capture and/or centrally store user profile data, including financial data, such as a composition of the investment caches. The application 232 may also be configured to retrieve additional financial data from multiple external data sources. The financial data received from financial data sources may include, for example, standard contribution limits, catch-up contribution limits, and/or individual contribution data.

In some embodiments, the application 232 generates and transmits a graphical user interface (GUI) on the user device, referring to either or both of the computing device 104 and the mobile device 106. The GUI may be configured to capture data (e.g., profile data) from the user 110. The data captured by the GUI and the application 232 may include sensitive data associated with a user profile. The sensitive data may include personally identifiable information (PII) data and domain specific data. Herein, the PII data may refer to the data that may be utilized for determining identity of the user 110. Examples of fields including the PII data in case of the application 232 may include permanent account numbers, date of birth, e-mail address, residential address, and mobile numbers, for example. The domain specific data includes the data that can pose a risk or affect the user 110 financially or otherwise, if disclosed in public. In an embodiment, the domain specific data may include domain specific fields, and can be generated by the enterprise system 200. Examples of said domain specific data for a financial institution such as a bank may include financial information such as debit and/or credit card numbers, CVV number, account balance, card expiry date, and other such fields, for example. The data may be gathered from multiple sources using the methods disclosed herein. Data shown and described herein is illustrative only and is not an exhaustive list of all data that is or might be used in an embodiment of the present disclosure.

In an exemplary embodiment, the application 232 may be configured to validate the data entered by the user 110 into at least some of the input/edit fields provided by the GUI. For example, the application 232 may be configured to check the data against minimum/maximum contribution amounts or unaccepted characters. If the data entered in the fields fails validation or is otherwise unacceptable, the application 232 may be configured to alert the user 110 and/or display an error message on the GUI. For example, the GUI of the application 232 may be configured to display red visual text to notify the user 110 that the data entered has failed validation, and thus the data must be corrected to order for the application 232 to store the data and/or proceed.

The data may be stored in a database and/or the storage device 234 and may be used by the computing device 206 to execute the steps of the methods disclosed herein. The data stored in the database and/or the storage device 234 may be generated as a result of the computing device 206 being programmed to perform the steps of the embodiments described herein.

In an embodiment, the application 232 is configured to facilitate investment cache contributions which applies and optimizes rules such as Internal Revenue Service tax code, for example, to maximize retirement savings. The GUI on the user device, referring to either or both of the computing device 104 and the mobile device 106 provided by the application 232 may be configured to display basic information about one or more caches (e.g., individual financial accounts, individual retirement accounts, and the like). The GUI may permit the user 110 to select options to learn more about levels of service available from the application 232 and/or enroll for enhanced services provided thereby.

In certain embodiments, the application 232 may permit a transfer of resources (i.e., monetary funds) from a financial cache (e.g., personal checking or savings account) of the user 110 to an investment cache (e.g., an individual retirement account) of the user 110. The financial cache of the user 110 may be one or more internal financial accounts of the user 110 held with the enterprise or one or more external financial accounts of the user 110 held by a third party enterprise. The investment cache of the user 110 may be one or more internal investment caches of the user 110 held with the enterprise or one or more external investment caches of the user 110 held by a third party enterprise. The enterprise system 200 may utilize one or more application program interfaces (APIs), through which the application 232 may obtain predetermined contribution limits, and preferably “real-time” or concurrent contribution limits, from at least one of the external systems 202 and 204 based upon the data of the user 110 retrieved from the database and/or the storage device 234. For example, the application 232 may determine whether a transfer of resources from the financial cache to the investment cache is permitted based upon the data (e.g., age, marital status, calendar date, etc.) of the user 110. It is understood that the predetermined contribution limit may comprise a predetermined standard limit for individuals younger than 50 years of age and a predetermined catch-up limit for individuals that are 50 years of age and older. It is also understood that the predetermined standard limit and the predetermined catch-up limit may be annually adjusted by the Internal Revenue Service, which makes concurrently obtaining the predetermined contribution limits from at least one of the external systems 202 and 204 based upon the data of the user 110 retrieved from the database and/or the storage device 234 critical feature of the present disclosure.

In a preferred embodiment, the application 232 permits the user 110 to contribute resources (e.g., monetary funds) from the one or more financial caches to the one or more investment caches for a current time period (e.g., a current tax year) and a previous time period (e.g., a previous tax year) up until a deadline (e.g., a due date for filing Federal income tax returns for the previous tax year). Once the deadline (e.g., the due date for filing Federal income tax returns for the previous tax year) has passed, the application 232, via the GUI, no longer permits the user 110 to contribute the resources into the one or more investment caches for the previous time period. In certain embodiments, the GUI displays the time period (e.g., the tax year) for contributing resources to the investment cache and permits the user 110 to select a desired time period for which the contribution of resources to the investment cache is to be made. It is understood that the user selection of the desired time period, received via the GUI, may be made by any suitable method such as by a drop down box, radio buttons, or other controls, for example. Prior to the deadline (e.g., the due date for filing Federal income tax returns for the previous tax year), the GUI presents the option of contributing resources for the current time period (e.g., the current tax year) and/or the previous time period (e.g., the previous tax year). However, when the deadline (e.g., the due date for filing Federal income tax returns for the previous tax year) has passed, the application 232 determines that the user 110 can only contribute resources to the current time period, and thereby the GUI is configured to no longer display the previous time period (e.g., the previous tax year) as a resource contribution option.

The application 232 may also permit the user 110 to set a desired frequency of the resource contribution to the investment cache. In certain embodiments, the GUI displays at least one frequency for contributing resources to the investment cache and permits the user 110 to select the desired frequency for which the contribution of resources to the investment cache is to be made. It is understood that the user selection of the desired frequency, received via the GUI, may be made by any suitable method such as by a drop down box, radio buttons, or other controls, for example. For example, the user 110, via the GUI, may set the desired frequency of the resource contribution to the investment cache as “one-time”. It is understood that the application 232 may provide, via the GUI, one or more frequency options such as one-time, monthly, semi-annual, and the like, for example. It is also understood that the application 232 may provide, via the GUI, a custom frequency option, wherein the user 110 enters the desired frequency of the resource contribution to the investment cache into an input field of the GUI.

The application 232 may also permit the user 110 to enter a desired amount for the resource contribution. In some embodiments, the application 232 provides at least one input field on the GUI associated with a desired amount of resources to be contributed to the investment cache. The application 232 receives, via the GUI, the desired amount of resources to be contributed to the investment cache. For example, the user 110 may enter the desired amount of resource into the at least one input field of the GUI. Once the user 110 confirms the resource contribution of the desired amount, the application 232 may cause the resources to transfer from the financial cache to the investment cache of the user 110 using other components of the enterprise system 200.

In some embodiments, the application 232 may prevent the desired amount to exceed the predetermined contribution limits obtained from at least one of the external systems 202 and 204. For example, if the user 110 enters a desired amount that exceeds the predetermined contribution limit obtained from the at least one of the external systems 202 and 204 based upon the data of the user 110, the application 232 may be configured to transmit an alert and/or display an error message on the GUI. For example, the GUI may be configured to display red visual text to notify the user 110 that the desired amount is unacceptable, and thus the desired amount must be corrected in order for the application 232 to proceed with the resource contribution. In some embodiments, the application 232 may notify the user 110 that the predetermined contribution limit has been exceeded by transmitting an electronic communication (i.e., a text, an email, etc.) to the user device, referring to either or both of the computing device 104 and the mobile device 106. In certain embodiments, the application 232 may also be configured to track and analyze the resource contributions of the user 110 to the one or more investment caches over the tax year in order to determine whether the predetermined contribution limits have been exceeded by the user 110.

The application 232 may also permit the user 110, via the GUI, to set a desired date of the resource contribution to the investment cache. The application 232 receives, via the GUI, the desired date of the resource contribution to the investment cache. In some embodiments, the application 232 provides at least one input field on the GUI to permit the user to enter a custom desired date of resource contribution to the investment cache. For example, the user 110 may enter the desired date of the resource contribution into at least one input field of the GUI. In certain embodiment, the application 232 may provide and the GUI may display one or more predetermined date options such as first day of the month, second Friday of the month, last day of the month, and the like, for example.

In some embodiments, the application 232 may also permit the user 110, via the GUI, to enter additional information related to the resource contribution to the investment cache. It is understood that the additional information may be entered into a custom input field of the GUI which is then received by the application 232.

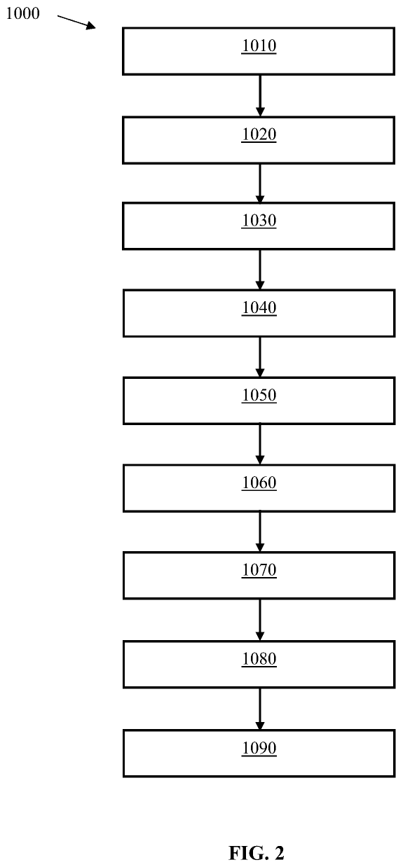

FIG. 2 illustrates a method 1000 for contributing resources to an investment cache using the application 232 in accordance with an embodiment of the present disclosure. The application 232 provides the GUI to implement the method 1000 for contributing resources to the investment cache. At step 1010, the user 110 logs into the application 232 through the user device, referring to either or both of the computing device 104 and the mobile device 106, by entering user data into the GUI. Based upon the user data received via the GUI and/or retrieved from the database and/or the storage device 234, the application 232 determines the predetermined contribution limits from at least one of the external systems 202 and 204 and the time period options for resource contributions. The GUI displays at least one input/field associated with the financial cache, the investment cache, the time period, the frequency, the amount, the transaction data, and additional information. From the GUI, the user 110, at step 1020, selects a financial cache from which the resources will be transferred. Thereafter, at step 1030, the user 110, via the GUI, selects an investment cache into which the resources will be contributed. The user 110, at step 1040, via the GUI then selects the desired time period for which the resources will be contributed. It is understood that the GUI displays both the current tax year and the previous tax year when the transaction date is on or before the deadline (e.g., the Federal tax return filing deadline) and only the current tax year when the transaction date is after the deadline. At step 1050, the user 110 using the GUI then selects the desired frequency at which the resource contributions are to be made from the financial cache into the investment cache. Thereafter, the user 110, at step 1060, via the GUI enters the desired amount of the resources to be contributed to the investment cache. The desired transaction date is then entered by the user 110 and received by the application 232 via the GUI at step 1070. Optionally, at step 1080, the user 110, via the input/fields provided by the GUI, may enter additional information associated with the resource contribution into the investment cache. At step 1080, the user 110, via the GUI, may then submit and/or confirm the resource contribution to the investment cache. The user 110 may then logout of the application 232 via the GUI at step 1090.

The use of the investment cache management application 232 improves the efficiency of the human agents 210 and operation of the computing system 206 in various respects. The disclosed system and method provide an ability for the human agents 210 to eliminate manual calculations and communications relating to certain tasks performed by the human agents 210 related to receiving resource contributions from the users 110. This may be especially relevant where the human agents 210 are avoiding a waste of resources when performing certain tasks, such as determining the predetermined contribution limits for the user and/or determining the time period options for the resource contributions and/or handling resource contributions that exceed the predetermined contribution limits. Additionally, the application 232 provides the user 110 greater insight into the Internal Revenue Service rules to maximize the resource contributions into the investment cache, and thereby retirement savings. Each of the described advantages reduces network traffic as experienced by the computing system 206 due automating the process to determine the predetermined contribution limits for the user 110 and/or the time period options for the resource contribution based upon the user data received by the application 232 via the GUI and/or stored in the database and/or the storage device 234.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A system for contributing to a cache, comprising:
a computing system including at least one processor and at least one memory, wherein the computing system executes computer-readable instructions for interaction with at least one user device having a graphical user interface; and
a network connection operatively connecting the at least one user device to the computing system;
wherein, upon execution of the computer-readable instructions, the at least one processor performs steps comprising:
receiving, via the graphical user interface, user data;
determining at least one time period for contributing resources to a cache based upon the user data;
displaying the at least one time period for contributing resources to the cache on the graphical user interface; and
receiving, via the graphical user interface, a user selection of a desired time period for contributing resources to the cache.

2. The system according to claim 1, further comprising determining at least one predetermined contribution limit for the cache based upon the user data.

3. The system according to claim 2, wherein the at least one predetermined contribution limit includes at least one of a standard contribution limit and a catch-up contribution limit.

4. The system according to claim 1, wherein the cache is an individual retirement account.

5. The system according to claim 1, further comprising displaying on the graphical user interface at least one frequency for contributing resources to the cache; and receiving, via the graphical user interface, a user selection of a desired frequency for contributing resources to the cache.

6. The system according to claim 1, wherein the at least one time period for contributing to the cache is at least one of a current tax year and a previous tax year.

7. The system according to claim 1, wherein the at least one time period for contributing to the cache is a current tax year when a time deadline has passed.

8. The system according to claim 7, wherein the time deadline is a due date for filing Federal income tax returns for a previous tax year.

9. The system according to claim 1, further comprising providing at least one input field on the graphical user interface associated with a desired amount of resources to be contributed to the cache; and receiving, via the graphical user interface, the desired amount of resources to be contributed to the cache.

10. The system according to claim 9, further comprising transmitting a communication to the at least one user device when the desired amount of resources to be contributed to the cache exceeds at least one predetermined contribution limit based upon the user data.

11. A method for contributing resources to a cache, comprising the steps of:
providing a computing system including at least one processor and at least one memory, wherein the computing system executes computer-readable instructions for interaction with at least one user device having a graphical user interface, and a network connection operatively connecting the at least one user device to the computing system;
receiving, via the graphical user interface, user data;
determining at least one time period for contributing resources to a cache based upon the user data;
displaying the at least one time period for contributing resources to the cache on the graphical user interface; and
receiving, via the graphical user interface, a user selection of a desired time period for contributing resources to the cache.

12. The method according to claim 11, further comprising determining at least one predetermined contribution limit for the cache based upon the user data.

13. The method according to claim 12, wherein the at least one predetermined contribution limit includes at least one of a standard contribution limit and a catch-up contribution limit.

14. The method according to claim 11, wherein the cache is an individual retirement account.

15. The method according to claim 11, further comprising displaying on the graphical user interface at least one frequency for contributing resources to the cache; and receiving, via the graphical user interface, a user selection of a desired frequency for contributing resources to the cache.

16. The method according to claim 11, wherein the at least one time period for contributing to the cache is at least one of a current tax year and a previous tax year.

17. The method according to claim 11, wherein the at least one time period for contributing to the cache is a current tax year when a time deadline has passed.

18. The method according to claim 11, further comprising providing at least one input field on the graphical user interface associated with a desired amount of resources to be contributed to the cache; and receiving, via the graphical user interface, the desired amount of resources to be contributed to the cache.

19. The method according to claim 18, further comprising transmitting a communication to the at least one user device when the desired amount of resources to be contributed to the cache exceeds at least one predetermined contribution limit based upon the user data.

20. A computer-implemented method for contributing resources to a cache using a graphical user interface, the method comprising:
receiving, via the graphical user interface, user data;
determining, by a processor, at least one time period for contributing resources to a cache based upon the user data;
displaying the at least one time period for contributing resources to the cache on the graphical user interface; and
receiving, via the graphical user interface, a user selection of a desired time period for contributing resources to the cache.
